(19) United States
(12) Patent Application Publication
(10) Pub. No.: US 2008/0289578 A1
(43) Pub. Date: Nov. 27, 2008

(54) Methods for Rapidly and Accurately Locating Avian Egg Blastoderms

(76) Inventors: Phillip L. Rybarczyk, JR., Chapel Hill, NC (US); Dipak Mahato, Raleigh, NC (US); Stephen P. Wolfe, Chapel Hill, NC (US); Nandini Mendu, Chapel Hill, NC (US)

Correspondence Address: PFIZER INC;Steve T. Zelson, 150 EAST 42ND STREET, 5TH FLOOR - STOP 49, NEW YORK, NY, 10017-5612, US

(21) Appl. No.: 12/064,305

(22) PCT Filed: Sep. 20, 2006
(86) PCT No.: PCT/US06/36541

§ 371 Date: Jul. 22, 2008

Related U.S. Application Data
(60) Provisional application No. 60/718,778, filed on Sep. 20, 2005.

(51) Int. Cl. A01K 43/00

(52) U.S. Cl. 119/6.8

(57) ABSTRACT

Methods of non-invasively locating blastoderms within avian eggs are provided. An opening is formed in the shell of an egg at a location under which a blastoderm is positioned based on the orientation of the egg; an image of an exposed inner shell membrane and underlying material is acquired; the acquired image is processed to enhance visibility of a blastoderm in the image; and the blastoderm is located in the image. A material may be applied to the egg to enhance transparency of the inner shell membrane prior to acquiring the image. Locating the blastoderm in the image may include determining location coordinates of the blastoderm in the image. These location coordinates may be transmitted to egg processing equipment for subsequent processing of the egg.

### RELATED APPLICATION

This application claims the benefit of and priority to U.S. Provisional Patent Application No. 60/718,778, filed Sep. 20, 2005, the disclosure of which is incorporated herein by reference as if set forth in its entirety.

### FIELD OF THE INVENTION

The present invention relates generally to eggs and, more particularly, to egg processing methods.

### BACKGROUND OF THE INVENTION

In poultry hatcheries and other egg processing facilities, eggs are handled and processed in large numbers. The term “processing” includes, but is not limited to, treating live eggs with medications, nutrients, hormones and/or other beneficial substances while the embryos are still in the egg (i.e., in ovo). In ovo injections of various substances into avian eggs have been employed to decrease post-hatch morbidity and mortality rates, increase the potential growth rates or eventual size of the resulting bird, and even to influence the gender determination of the embryo. Injection of vaccines into live eggs have been effectively employed to immunize birds in ovo.

There are a number of applications for which it is desirable to inject eggs containing early avian embryos. For example, it may be desirable to deliver a substance to an early embryo, such as a blastoderm. To illustrate, it may be desirable in the poultry industry to manipulate an early embryo in ovo to introduce a foreign nucleic acid molecule (i.e., to create a transgenic bird) or to introduce a foreign cell(s) (i.e., to create a chimeric bird) into the developing embryo. Unfortunately, it is often difficult to locate the blastoderm inside an avian egg and, even if located, the visibility is typically poor, particularly through the inner shell membrane of an egg. In addition, the color and contrast of a blastoderm and surrounding egg material are typically similar, thereby further making it difficult to visually detect the blastoderm. The blastoderm can more easily be detected if an opening is made in the inner shell membrane (after an opening has been made in the shell). However, a breach of the inner shell membrane may damage the developing embryo and may subsequently lead to failure to hatch. In addition, conventional methods of injecting material into blastoderms are often unreliable because of the difficulty in locating a blastoderm.

Accordingly, there is a need in the art for improved methods of locating and manipulating the blastoderm within avian eggs and without causing damage to the egg.

### SUMMARY OF THE INVENTION

In view of the above discussion, methods of locating blastoderms within avian eggs are provided. According to some embodiments of the present invention, an opening is formed in the shell of an egg at a location under which a blastoderm is positioned based on the orientation of the egg and such that an inner shell membrane is exposed; an image of the exposed inner shell membrane and underlying material is acquired; the acquired image is processed to enhance visibility of the blastoderm in the image; and the blastoderm is located in the image. A material may be applied to the egg to enhance transparency of the inner shell membrane prior to acquiring the image. Locating the blastoderm in the image may include determining location coordinates of the blastoderm in the image. These location coordinates may be transmitted to egg processing equipment for subsequent processing of the egg.

According to some embodiments of the present invention, subsequent egg processing may include extending a device through the opening in the egg shell and into the located blastoderm. The device may be a delivery device that releases a substance into the blastoderm, and/or a sampling device that removes sample material (e.g., blastodermal cells, cells adjacent to the blastoderm, etc.) from the blastoderm, and/or a detector device that detects information from within the egg.

According to some embodiments of the present invention, the opening in the egg may be sealed after acquiring the image or after further processing (e.g., injecting a substance into the egg, removing material from the egg, detecting information from within the egg, etc.). The sealed egg may then be incubated until hatch.

According to some embodiments of the present invention, a method of determining whether an avian egg is fertile, includes forming an opening within a portion of the shell of the egg; acquiring an image of an exposed inner shell membrane and underlying material; processing the acquired image to determine the presence of a blastoderm in the image; and assessing fertility of the avian egg based upon the presence or absence of a blastoderm.

### BRIEF DESCRIPTION OF THE DRAWINGS

FIG. 1 is a side section view of a conventional avian egg.

FIG. 2 is a flow chart illustrating operations for locating a blastoderm within an avian egg, according to some embodiments of the present invention.

FIG. 3A is a block diagram that illustrates an overhead digital video camera configured to acquire images of a windowed egg, according to some embodiments of the present invention.

FIG. 3B is a representative image of a blastoderm as captured by the video camera of FIG. 3A.

FIG. 3C illustrates the representative image of FIG. 3B after processing to increase contrast of the blastoderm, according to some embodiments of the present invention.

FIG. 3D illustrates the representative image of FIG. 3C with a location box placed around the blastoderm, according to some embodiments of the present invention.

FIGS. 4A-4D are photographs of windowed eggs, wherein the exposed inner shell membranes in FIGS. 4A and 4C are untreated and wherein the exposed inner shell membranes in FIGS. 4B and 4D are treated with DMSO to increase the visibility of the blastoderm.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines are used for clarity to indicate continuation, and may illustrate optional features or operations unless specified otherwise. All publications, patent applications, patents, and other references mentioned herein are incorporated herein by reference in their entireties.

It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only. It will also be appreciated by those of skill in the art that references to a structure or feature that is disposed “adjacent” another feature may have portions that overlap or underlie the adjacent feature.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

The terms “avian” and “avian subjects,” as used herein, are intended to include males and females of any avian species, but are primarily intended to encompass poultry which are commercially raised for eggs, meat or as pets. Accordingly, the terms “avian” and “avian subject” are particularly intended to encompass various birds including, but not limited to, chickens, turkeys, ducks, geese, quail, pheasant, parakeets, parrots, cockatoo, cockatiel, ostrich, emu, etc.

As used herein, the term “early embryo” refers to an avian embryo from the time of lay (blastodermal stage) through about the developmental stage where primordial germ cells (PGCs) are migrating. With particular respect to chicken embryos, an “early embryo” is generally about an embryonic stage 20 (H&H) embryo or earlier. The developmental stages of the chicken embryo are well-understood in the art, see e.g., The Atlas of Chick Development, R. Bellairs & M. Osmond, eds., Academic Press, 1998.

As used herein, the term “blastoderm” has its understood meaning in the art. Generally, a blastoderm includes an embryo from the time of lay through the end of gastrulation. The blastoderm is sometimes referred to by the alternative designations “germinal disc” or “embryonic disc” in the art. A blastoderm may be described as a flattened disc of cells that forms during cleavage in the early embryo and persists until the end of gastrulation. By the time of laying, two major regions of the blastoderm are visible, the centrally-situated area pellucida and the peripherally-located area opaca (The Atlas of Chick Development, R. Bellairs & M. Osmond, eds., Academic Press, 1998). With particular respect to chicken embryos, the blastoderm is typically characterized as an embryo from the time of lay (i.e., Stage IX or Stage X EG&K) through about stage XIII (EG&K) or higher.

As used herein, the terms “injection” and “injecting” encompass methods of inserting a device into an egg or embryo, including methods of delivering or discharging a substance into an egg or embryo, methods of removing a substance (i.e., a sample) from an egg or embryo, and/or methods of inserting a detector device into an egg or embryo.

The terms “chimeric bird” or “chimeric embryo” refer to a recipient bird or embryo, respectively, that contains cells from another bird or embryo, referred to as a “donor.” The terms “transgenic bird” and “transgenic embryo” are used herein in accordance with their generally understood meanings in the art. A transgenic bird or transgenic embryo contains a foreign nucleic acid sequence in one or more cells.

As used herein, the term “membrane” refers to any layer of tissue within an egg. Exemplary membranes within an egg include, but are not limited to, the outer shell membrane, inner shell membrane, chorio-allantoic membrane, vitelline membrane, and amniotic membrane (amnion).

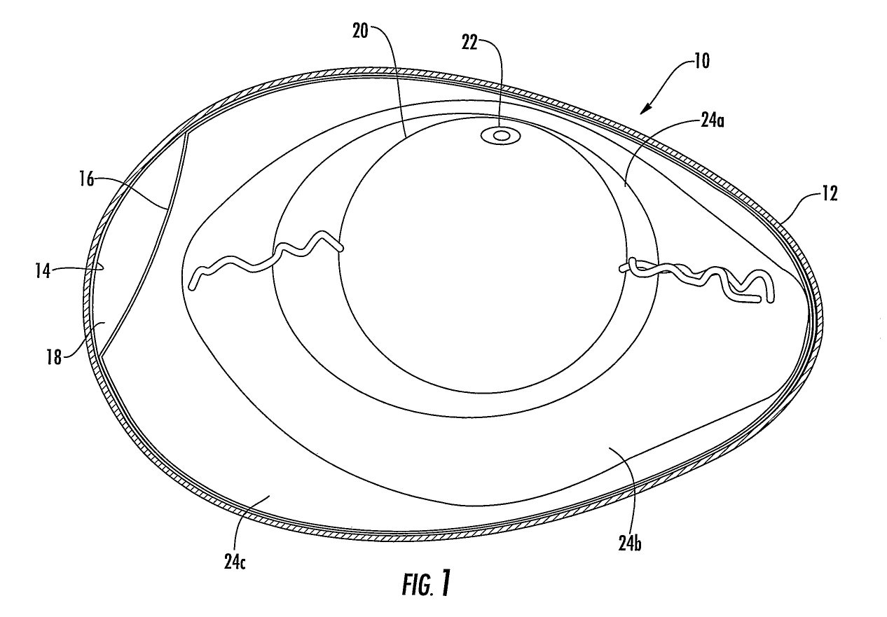

Referring now to FIG. 1, an avian egg 10 is illustrated. The illustrated egg 10 includes a shell 12, an outer shell membrane 14, an inner shell membrane 16, and an air cell 18 at the blunt end of the egg 10 between the inner and outer shell membranes 14, 16. The illustrated egg 10 also includes a yolk 20 and blastoderm 22 surrounded by inner thin albumen 24a, outer thick albumen 24b, and outer thin albumen 24c.

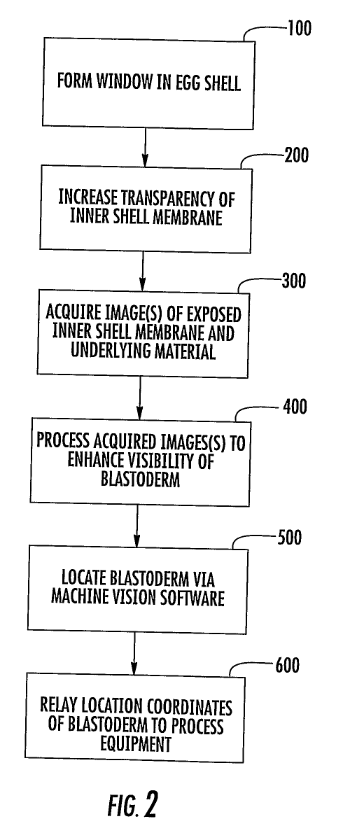

FIG. 2 is a flow chart that illustrates methods of locating the blastoderm within avian eggs, according to some embodiments of the present invention. It should be noted that the functions noted in the blocks may occur out of the order noted in FIG. 2. Two (or more) blocks shown in succession may in fact be executed substantially concurrently or the blocks may sometimes be executed in the reverse or different order, depending on the functionality involved.

In addition, it should be noted that embodiments of the present invention may be utilized at various stages of embryonic development of an avian egg. Embodiments of the present invention are not limited to the blastoderm stage of avian eggs. For example, embodiments of the present invention may be utilized at stages past blastoderm, such as Day 3-5 of incubation.

Initially, a portion of the egg shell and a portion of the outer shell membrane of an egg is removed to form an opening or window that reveals the inner shell membrane (Block 100). Preferably, the inner shell membrane is not adversely affected by forming a window in the egg shell and remains essentially intact. The window may be formed in various ways including, for example, via a punch, a drill or via other devices known to those skilled in the art.

In addition, the window may be made at any suitable location of an egg, e.g., in the side of an egg near the equatorial axis, at either end of an egg, etc. In some embodiments of the invention, the opening in the egg shell is introduced at an upward facing portion of the shell of a generally horizontally positioned egg and over the air cell. Those skilled in the art will appreciate that the early embryo (e.g., blastoderm) will typically locate itself in an area at or near the uppermost portion of an egg. Thus, the opening in the egg shell will generally be made in the uppermost portion of an egg near where the early embryo (e.g., blastoderm) is expected to locate unless measures are taken to steer the embryo to a different position within an egg.

According to some embodiments of the present invention, the surface of an egg, at least around the site of formation of the window, may be sanitized to reduce microbial (or other) contamination (e.g., with an alcohol or other sanitizing solution). However, sanitizing an egg, including the site of the window, is not required with respect to embodiments of the present invention.

According to some embodiments of the present invention, the transparency of the inner shell membrane may be increased, for example, by applying materials such as dimethyl sulfoxide (DMSO) or glycerol to the inner shell membrane (Block 200). Other materials that can enhance the transparency of the inner shell membrane or that can otherwise assist imaging may also be utilized including, but not limited to, water, alcohol, phosphate-buffered saline (PBS), canola oil, vegetable oil, mineral oil, triacetin, acetone, ethylene glycol, monomethyl ether, etc.

One or more digital images are then taken of the exposed inner shell membrane and underlying material (including the blastoderm) (Block 300). Single frame digital images may be acquired via a digital camera and/or digital video images may be acquired via a digital video camera, according to some embodiments of the present invention. Embodiments of the present invention are not limited to digital imaging, however. Non-digital images of the exposed inner shell membrane and underlying material may be acquired and then converted into digital format for subsequent image processing, as described below.

Other imaging technologies and techniques may be utilized in acquiring images of a blastoderm according to embodiments of the present invention. For example, High Resolution Ultrasound and Optical Coherence Tomography (OCT) may be utilized. For example, a small OCT probe may be positioned at the tip of a needle or other device configured to be inserted in ovo. OCT could produce a three-dimensional image of the blastoderm and underlying subgerminal cavity by taking a series of several overhead scans and looking for a fluid-filled region. The needle may then be inserted within an egg (e.g., under an essentially intact inner shell membrane).

The acquired digital image(s) may then be subjected to one or more image processing techniques to enhance the visibility of the blastoderm in the image (Block 400). However, image processing is not required according to embodiments of the present invention. Visibility of a blastoderm may be sufficient in an unprocessed image. The blastoderm is then located using “machine vision” software (Block 500). The location coordinates of the blastoderm within the digital image are then relayed to process equipment that will insert a device through the window and inner shell membrane and into the blastoderm and/or area adjacent to the blastoderm (Block 600). The device may inject material, and/or may sample material, and/or may detect information from within the egg. If the device inserted within the egg is a delivery device, one or more substances may be released through the delivery device and deposited into the blastoderm and/or in close proximity thereto. One or more substances may also be deposited in other locations within the egg. Embodiments of the present invention are not limited to the deposition of one or more substances at or near the blastoderm.

If the device inserted within the egg is a sampling device, one or more samples (e.g., blastodermal cells, etc.) may be removed from the blastoderm and/or from close proximity thereto. One or more samples may be taken from the extra-embryonic portions of the egg (e.g., the yolk or the albumen). For example, a sample may be taken from the albumen to determine the presence or absence of microbial contamination (e.g., Salmonella) therein, etc.

The sampling device may be a needle configured to draw material (e.g., allantoic fluid, other fluid, etc.) from the egg, as would be understood by those skilled in the art. For example, the needle may have a blunt tip and an axially-extending lumen that terminates at an aperture formed within a portion of the needle adjacent the tip. Material can be drawn into the lumen via the aperture upon subjecting the lumen to vacuum. The blunt tip prevents the lumen from becoming clogged with material.

Typically, a sample is removed from the egg to obtain information therefrom. The sample may be removed, for example, in connection with methods of sexing or determining the viability of an embryo. To illustrate, a sample containing cells may be removed from the embryo, and the cells may be analyzed (typically after removal from the egg) to detect the sex chromosomes or sex-specific sequences on the chromosomes, as known by those skilled in the art. The sample may also be used for any other DNA based assay, e.g., to determine the presence of a particular gene or allele of interest in the embryo.

In some embodiments, a multi-site injection or sampling device may be used, for example, as described in U.S. Pat. No. 6,032,612. Other exemplary delivery and/or sampling devices include those described in U.S. Pat. No. 5,136,979; U.S. Pat. Nos. 4,681,063 and 4,903,635; and U.S. Pat. Nos. 4,040,388, 4,469,047, and 4,593,646.

If the device inserted within the egg is a detector, various types of information from the interior of the egg may be detected. The detector may be inserted into an extra-embryonic location of the egg (e.g., the yolk or the air cell). Alternatively, the detector may be placed in close proximity (as defined above) to the embryo. In other embodiments, the detector may be placed into the area pellucida or the area opaca of the embryo or into the subgerminal cavity. The detector device may be used to collect information including, but not limited to, the size of the embryo, the location of the embryo, the developmental stage of the embryo and/or any characteristic feature of the embryo, the sex of the embryo, and/or the viability of the embryo. The detector device may obtain information regarding the location of the embryo and the subgerminal cavity.

The information may be captured by an instrument (e.g., a computer or other data processor) that is connected to the detector. Various types of detectors may be utilized including, but not limited to, electrical sensors, optical sensors, chemical sensors, temperature sensors, acoustic sensors, pressure sensors, or any other device for detecting a physical or chemical parameter. Exemplary detectors are described, for example, in U.S. Pat. No. 6,244,214 to Hebrank.

After injecting a substance and/or removing a sample and/or detecting information from the egg, the device is retracted from the egg. The small opening in the egg shell may be sealed with a sealant and the egg may be incubated until hatch.

Those skilled in the art will appreciate that methods of the present invention may be carried out on a plurality of eggs, e.g., in a commercial poultry operation. Moreover, the methods described herein may be fully manual, fully automated, or semi-automated.

An imaging system, according to some embodiments of the present invention, includes hardware and software components. The hardware components include a light source (e.g., 150 watt halogen light source, etc.), a digital video camera and appropriate focusing lens, and a computer or other data processor connected to the camera via, for example, a video card (e.g., an IEEE 1394 (“firewire”) card). According to a particular embodiment, a camera having 12-bit or higher resolution with high dynamic range is utilized. An exemplary camera is a monochrome Basler A601 HDR with high dynamic range (up to 112 dB) with 16-bit resolution and progressive scan CMOS sensor technology. However, various cameras may be utilized. Embodiments of the present invention are not limited to a particular camera, lens, and/or image capture and storage technology (e.g., CCD or CMOS). Embodiments of the present invention are not limited to a particular type of light source, or to a particular light source wattage, or to a particular location and/or orientation of a light source.

According to some embodiments of the present invention, additional components that may be utilized include optical components such as light filters and/or light sources (including those commercially available from sources such as Edmund Optics, Omega Optics, etc.) that aid in the contrasting of the (white) blastoderm against its (yellow) surroundings. For example, Applicants have found that a blastoderm becomes much more visible if blue light is used for illumination thereof. Blue light may be produced by a blue light source or by a white light source filtered with a blue filtering media (e.g., lens, etc.). This improvement in visibility aids the software component, which contains the image acquisition and processing algorithms that search for the blastoderm in each acquired image.

Image processing, according to some embodiments of the present invention, is utilized to locate a blastoderm in an image, and, optionally, to enhance the contrast of the blastoderm in the image. Image processing for locating a blastoderm includes algorithms such as pattern matching and blob analysis. Image processing for enhancing the contrast of a blastoderm in an image includes RGB plane extractions and various other filtering algorithms (e.g., smoothing, edge detection, Gaussian, etc). Exemplary image processing techniques that may be utilized in accordance with embodiments of the present invention are described in U.S. Pat. Nos. 6,219,452; 6,222,940; 6,229,921; 6,256,625; 6,370,270; 6,366,686; 6,493,079; and 6,535,640.

For example, in pattern matching a user selects a template image for the software to find in subsequent images, and then sets other parameters such as number of matches to find, depth of search (fine to coarse), scoring limitations, and rotated patterns. Pattern matching, blob analysis, RGB plane extraction and other image processing techniques are well known to those skilled in the art and need not be described further herein.

Exemplary imaging software that may be used in accordance with embodiments of the present invention includes Vision Builder for Automated Inspection, available from National Instruments, Inc. This software integrates well with LabVIEW software, also available from National Instruments, Inc., and which is utilized with other egg processing procedures, including pressure sensing and injection.

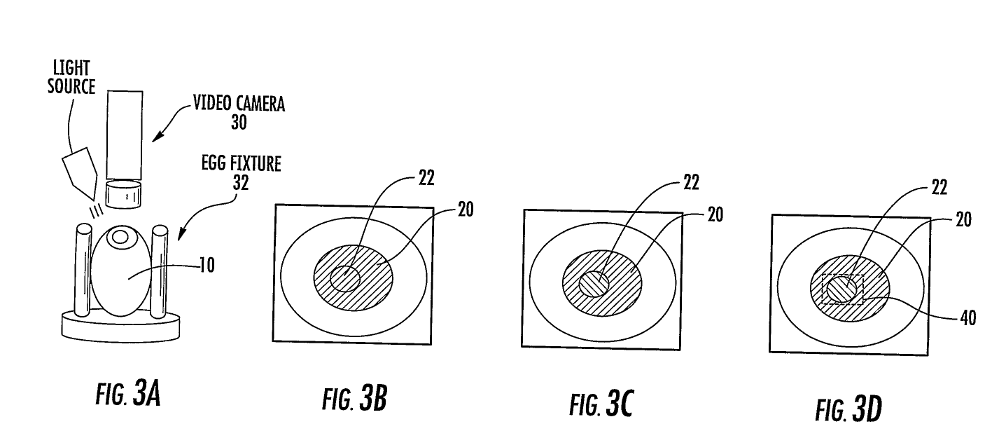

Referring to FIG. 3A, an overhead digital video camera 30 is configured to acquire images of a windowed egg 10 (i.e., an egg with an opening formed in the shell as described above) held in place via a fixture or cradle 32. Eggs may be held in place via various types of devices, without limitation. Moreover, multiple eggs may be processed together in accordance with some embodiments of the present invention. For example, an egg flat may function as a cradle 32 for a plurality of eggs.

A representative image of a blastoderm 22 as captured by video camera 30 is shown in FIG. 3B. The illustrated blastoderm 22 is barely distinguishable from the surrounding yolk 20.

Embodiments of the present invention are not limited to the illustrated orientation of the light source. According to other embodiments of the present invention, an axial diffuse illuminator (available, for example, from Advanced Illumination, Inc.) may be located between the camera and the egg. The axial diffuse illuminator has angled dichroic mirrors surrounded with (blue) LEDs to direct the light appropriately to the blastoderm and then back to the camera 30.

Referring to FIG. 3C, processing of the image of FIG. 3B via image processing software produces an image where the blastoderm 22 in the image has increased in contrast relative to the yolk 20. In FIG. 3D, software detects the blastoderm 22 and places a box 40 around the blastoderm 22 in the image. The coordinates of this box (e.g., the geometric midpoint) can be provided to a device to be inserted into and/or adjacent to the blastoderm 22, as described above.

According to some embodiments of the present invention, an imaging system as described above can be scaled up to handle multiple eggs at once, and may include multiple cameras. Moreover, eggs in virtually any orientation, including horizontal, vertical, tilted, etc., can be processed according to some embodiments of the present invention.

Some embodiments of the present invention are particularly adapted to accurately and rapidly locate the blastoderm in fertile, unincubated Day 0 eggs. Some embodiments of the present invention may also be utilized in imaging embryos during incubation, e.g., during Days 0-5.

Some embodiments of the present invention are not limited to locating the blastoderm within avian eggs. Embryo growth may be monitored by some embodiments of the present invention. According to some embodiments of the present invention, the location of specific blood vessels can be determined to facilitate delivery of a protein or vector to the circulatory system. According to some embodiments of the present invention, imaging techniques may be utilized to determine if an egg is fertile or infertile. According to some embodiments of the present invention, imaging techniques may be utilized in conjunction with embryo steering or positioning techniques. Embryo steering and positioning techniques are described in U.S. patent application Ser. No. 10/216,427, which is commonly owned by the assignee of the present application.

A blastodisc (typically just one or two cells) is the region at the surface of an egg yolk where embryo formation occurs, regardless of whether or not the ovum has been fertilized. Once it becomes fertilized, the blastodisc will eventually become the blastoderm (i.e., the blastodisc will multiply from one or two cells to tens of thousands of cells). Thus, a non-fertile egg will not have a blastoderm.

According to some embodiments of the present invention, a method of determining whether an avian egg is fertile, includes forming an opening within a portion of the shell of the egg, and acquiring an image of an exposed inner shell membrane and underlying material. The acquired image is processed to determine the presence of a blastoderm in the image. The fertility of the egg is based upon detecting the presence or absence of a blastoderm in the image. If a blastoderm is not detected or if a shape in the image does not match the characteristics of a blastoderm (e.g., shape, size, etc.), the egg is considered non fertile.

### EXAMPLE 1

One major impediment to injecting a blastoderm through the inner shell membrane is that it is often difficult to see the blastoderm through the membrane because the membrane, although somewhat translucent, typically is not transparent. To address this difficulty, we attempted to make the membrane more transparent by coating it with several liquid substances. Eggs were stored in accordance with standard industry practice (75% relative humidity, 16C, 8 days) prior to manipulation. The shell and outer shell membrane were removed at the location of the air cell, exposing the intact inner shell membrane. The inner shell membrane was coated with one of 4 different liquids (water, mineral oil, glycerol, or DMSO) using a cotton swab.

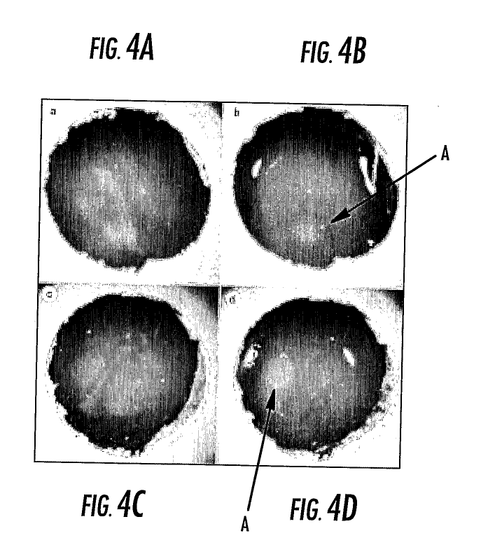

The use of water and mineral oil had virtually no effect on the clarity of the inner shell membrane. Glycerol and DMSO both had the effect of ‘clearing’ the inner shell membrane. While it was not rendered transparent, the clarity was definitely improved. In cases where the blastoderm was somewhat visible, the addition of glycerol or DMSO improved blastoderm visibility and depth perception. In some cases where the blastoderm was not visible at all, addition of glycerol or DMSO usually allowed the visualization of the blastoderm, and improved the ability to distinguish infertile eggs (see FIGS. 4A-4D.

FIGS. 4A-4D illustrate increased visibility of the blastoderm within eggs using DMSO. FIGS. 4A and 4C illustrate untreated eggs and FIGS. 4B and 4D illustrate the same eggs swabbed with DMSO. The blastoderms in FIGS. 4B and 4D are illustrated via arrow A. Note that while the blastoderm in FIG. 4A appears as a fuzzy blur, treatment with DMSO greatly improved the sharpness of the blastoderm in the image. In FIG. 4C, where the blastoderm is not visible at all, addition of DMSO made the blastoderm clearly visible in the image, as shown in FIG. 4D.

DMSO seemed to give slightly better visibility than glycerol. Glycerol tended to be difficult to work with (sticky and left a glob on the inner shell membrane). DMSO quickly evaporated or diffused through the membrane, and left no trace. Treatment of the inner shell membrane with DMSO may be a very useful technique to assist in visualization of the blastoderm for manual injection.

### EXAMPLE 2

To evaluate toxicity of DMSO to embryonic development, embryos were treated with DMSO as described in Example 1 and set to hatch, and then compared with embryos with no DMSO treatment. To further evaluate the effects of DMSO on clearing the inner shell membrane, eggs were used that had been stored for only 4 days. Three treatment groups were used:
A) Window+DMSO: Eggs windowed at the blunt end, without damaging the inner shell membrane. The inner shell membrane was swabbed with DMSO. Only eggs with a visible blastoderm were kept in this treatment group. The blastoderm was pierced with a Humagen micropipette, filled with KRB medium, to simulate injection. The eggs were sealed with silicone+tape. N=42 (i.e., 42 eggs were in this group).
B) Window+no DMSO: Eggs were windowed at the blunt end, without damaging the inner shell membrane. The eggs were sealed with silicone+tape. N=39 (i.e., 39 eggs were in this group).
C) Unmanipulated: Eggs were totally unmanipulated and set to hatch. N=54 (i.e., 54 eggs were in this group). Hatch Results:

| Treatment | A | B | C |
|---|---|---|---|
| group | 42 | 39 | 54 |

(A) Embryos dead before injection, transfer, or
upside down, or malformed

| | | | |
|---|---|---|---|
| Infertile | | 1 | 3 |
| Early dead | 8 | 2 | 2 |
| Middle Dead | 2 | 2 | |
| Rot | 2 | | |
| Crack shell | | | |
| Malformed | | | |
| Upside down | | | |
| TOTAL A | 12 | 5 | 5 |

(B) Embryos that died after injection, transfer, or
live that didn't hatch

| | | | |
|---|---|---|---|
| Late Dead | 3 | | |
| Live Pip | 1 | 2 | 1 |
| Dead pip | | | |
| Live not pip | | | |
| Cull | | | |
| Dead | | | |
| Malposition | 2 | 3 | 1 |
| TOTAL B | 6 | 5 | 2 |

(C) Normal hatched

| | | | |
|---|---|---|---|
| TOTAL C | 24 (57%) | 29 (74%) | 47 (87%) |

It should be noted that there were rotten eggs in the incubator (from another study), that had leaked bacteria over treatment group A, probably resulting in the ‘rot’ classification, and the late dead chicks.

There was a reduction in hatch among those eggs treated with DMSO compared to eggs that were just windowed and sealed. Part of this reduction may have been caused by bacterial contamination from other eggs in the incubator. There are more early dead eggs in group A than B or C. Since there are fewer or no infertile eggs in group A, it is likely that this increase in early deads is due to DMSO toxicity. The small risk of DMSO toxicity may be outweighed by increased visibility and injectability of the blastoderm.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of locating a blastoderm within an avian egg, comprising:
forming an opening in the shell of an egg at a location under which a blastoderm is positioned and such that an inner shell membrane is exposed;
acquiring an image of the exposed inner shell membrane and underlying material;
processing the acquired image to enhance visibility of a blastoderm in the image; and
locating the blastoderm in the image.

2. The method of claim 1, further comprising applying a material to egg to the inner shell membrane to enhance transparency thereof prior to acquiring the image.

3. The method of claim 1, wherein locating the blastoderm in the image comprises determining location coordinates of the blastoderm in the image, and further comprising transmitting the location coordinates of the blastoderm to egg processing equipment.

4. The method of claim 3, further comprising extending a device through the opening in the egg shell and into the blastoderm in response to receiving the location coordinates.

5. The method of claim 4, wherein the device is a delivery device that releases a substance into the blastoderm.

6. The method of claim 4, wherein the device is a sampling device that removes sample material from the blastoderm.

7. The method of claim 4, wherein the device is a detector device that detects information from within the egg.

8. The method of claim 1, wherein the egg is selected from the group consisting of chicken, turkey, duck, goose, quail, pheasant, parakeet, parrot, cockatoo, cockatiel, ostrich and emu eggs.

9. The method of claim 1, further comprising sealing the small opening in the egg shell after acquiring the image.

10. The method of claim 1, further comprising incubating the egg until hatch.

11. The method of claim 5, wherein the device is a multiple injection delivery device.

12. The method of claim 6, wherein the sample material removed from the egg comprises blastodermal cells.

13. The method of claim 7, wherein the detector device is selected from the group consisting of electrical sensors, optical sensors, chemical sensors, temperature sensors, acoustic sensors, and pressure sensors.

14. A method of locating a blastoderm within an avian egg, comprising:
forming an opening in the shell of an egg at a location under which a blastoderm is positioned and such that an inner shell membrane is exposed;
applying a material to the inner shell membrane to enhance transparency thereof;
acquiring an image of the exposed inner shell membrane and underlying material;
processing the acquired image to enhance visibility of a blastoderm in the image;
determining location coordinates of the blastoderm in the image; and
transmitting the location coordinates to egg processing equipment.

15. The method of claim 14, further comprising extending a device through the opening in the egg shell and into the blastoderm in response to receiving the location coordinates.

16. The method of claim 15, wherein the device is a delivery device that releases a substance into the blastoderm.

17. The method of claim 15, wherein the device is a sampling device that removes sample material from the blastoderm.

18. The method of claim 15, wherein the device is a detector device that detects information from within the egg.

19. The method of claim 15, further comprising sealing the small opening in the egg shell after acquiring the image.

20. A method of determining whether an avian egg is fertile, comprising:
forming an opening in the shell of an egg at a location under which a blastoderm is likely positioned and such that an inner shell membrane is exposed;
acquiring an image of the exposed inner shell membrane and underlying material;
processing the acquired image to determine if a blastoderm is present in the image; and
assessing fertility of the avian egg based upon the presence or absence of a blastoderm in the image.
